(19) United States
(12) Patent Application Publication
(10) Pub. No.: US 2025/0153528 A1
(43) Pub. Date: May 15, 2025

(54) VEHICLE WITH AN ACTIVE CHASSIS

(71) Applicant: AUDI AG, Ingolstadt (DE)

(72) Inventors: Christian SCHMALKOKE, lngolstadt (DE); Hanno STINGL, Kipfenberg (DE); Timo STRUTZ, Wettstetten (DE); Tobias TEMPLER, Hitzhofen (DE)

(73) Assignee: AUDI AG, Ingolstadt (DE)

(21) Appl. No.: 18/907,990

(22) Filed: Oct. 7, 2024

(30) Foreign Application Priority Data
Nov. 14, 2023 (DE) 102023131664.8

(51) Int. Cl. B60G 17/016

(52) U.S. Cl. CPC B60G 17/016; B60G 2400/252; B60G 2500/10; B60G 2800/012

(57) ABSTRACT

A vehicle with an active chassis, in which each vehicle wheel is linked to the vehicle body by a wheel suspension which has a vibration/damping device with a vertical dynamics system which can be controlled by a chassis control unit, namely by adjusting the roll stiffness and the articulation capability of the vehicle which behaves in the opposite direction. The chassis control unit is assigned a user-operable input with which the roll stiffness and the opposing articulation capability can be manually adjusted, in particular during off-road driving.

### FIELD

The invention relates to a vehicle with an active chassis.

In such an active chassis, each of the vehicle wheels is linked to the vehicle body via a wheel suspension that has an active vertical dynamics system, for example an electromechanical or hydraulic one. Using the vertical dynamics system, the height of the vehicle body can be actively adjusted to increase the vehicle's driving dynamics and driving comfort.

### BACKGROUND

A generic vehicle has a chassis control unit which controls the vertical dynamics system on the basis of driving parameters, namely by adjusting the roll stiffness and the articulation capability of the vehicle, which usually behaves in opposite directions.

In an off-road driving situation, problems with ground clearance and/or traction may occur due to the condition of the road. If there is insufficient ground clearance, the vehicle will sit on the ground, while if there is insufficient traction, the vehicle will lift off the ground with one wheel, for example, which means it cannot build up traction.

It has been shown that sufficient ground clearance can be provided if the vehicle has a high roll stiffness and thus a reduced articulation capability of one vehicle axle relative to the other vehicle axle. Conversely, sufficient traction capability (i.e. the vehicle wheel builds up traction with respect to the ground) can be provided with low roll stiffness and thus an increased articulation capability between the two vehicle axles.

The current prior art has the following disadvantage: When using wheel suspensions with stabilizers, an articulation-optimized design and control or system setting of the chassis control unit can lead to ground clearance or tipping problems.

A wheel suspension for off-road vehicles is known from US 2022/0016949 A1. The wheel suspension may include an adjustable element connecting a stabilizer to the respective suspensions. The suspension systems may also include a torque actuator connected to a stabilizer bar. From DE 10 2011 013 579 A1 a method for adjusting the height of a vehicle body is known. In the method, in a first operating state, a body height with respect to at least one vehicle wheel is adjusted by means of an actuator assigned to the wheel as a function of a roll state of the vehicle. In a second operating state, a predetermined body height is set by means of the actuator. The second operating state is locked by means of a locking device. This enables particularly energy-efficient and low-wear operation of the vehicle off-road.

### SUMMARY

The object of the invention is to provide a vehicle with an active chassis in which the off-road suitability can be increased in a simple manner compared to the prior art.

The invention is based on a vehicle with an active chassis in which each vehicle wheel is linked on the vehicle body in a wheel suspension. The wheel suspension has a vibration/damping device with a vertical dynamics system. In addition, a chassis control unit is provided which controls the vertical dynamics system on the basis of driving parameters, whereby the roll stiffness and the opposing articulation capability of the vehicle can be adjusted. It has been shown that sufficient ground clearance can be provided if the vehicle has a high roll stiffness and thus a low articulation capability of one vehicle axle with respect to the other vehicle axle. Conversely, sufficient traction capability (i.e. the vehicle wheel builds up traction with respect to the ground) can be provided with low roll stiffness and thus with increased articulation capability between the two vehicle axles.

According to the characterizing part of claim 1, the chassis control unit is assigned a user-operable input means with which the roll stiffness and the articulation capability, which generally behaves in the opposite direction, can be manually adjusted, in particular during off-road driving. In this way, the driver can select an optimum between sufficient articulation capability and sufficient ground clearance by operating the input means, thus ensuring traction build-up between the vehicle wheel and the road during off-road driving.

The roll stiffness and the articulation capability usually behave in opposite directions to each other: A high articulation capability is achieved with low roll stiffness. Conversely, a low articulation capability is achieved with a high roll stiffness. The articulation capability is determined by a ramp travel index RTI. The higher the roll stiffness, the higher the “articulation stiffness”, the lower the articulation capability.

In a technical implementation, the input means can be adjusted to a position in which a reduced roll stiffness and thus an increased articulation capability are set for maximum traction capability with minimal ground clearance. On the other hand, for maximum ground clearance with reduced traction capability, the input means can be adjusted to a second setting position in which an increased roll stiffness and a correspondingly reduced articulation capability are set. For medium traction capability and medium ground clearance, the input means can be adjusted to a further setting position in which medium roll stiffness with correspondingly medium articulation capability is set.

Alternatively and/or in addition to the aforementioned first embodiment, the invention also relates to a vehicle with an active chassis in which the vertical dynamics system compresses according to a compression characteristic curve which increases progressively with an increase in spring stiffness at a correspondingly large compression. According to the invention, the chassis control unit can be assigned a user-operable input means with which the compression characteristic curve can be manually adjusted, in particular its characteristic curve slope and/or the maximum available compression travel. By reducing the compression travel, sufficient ground clearance can be provided, especially when driving off-road. This aspect of the invention is based on the fact that problems with ground clearance that occur during off-road driving can often be solved by adjusting the compression travel of the respective vertical dynamics system.

For maximum traction capability, the input means can be adjusted to a setting position in which there is no limitation on the maximum compression travel that can be provided by the vertical dynamics system. Alternatively, the input means for maximum ground clearance can be adjusted to a setting position in which the compression travel is maximally limited. For medium traction and medium ground clearance, the input means can be adjusted to a further setting position in which a medium limitation of compression travel occurs.

In a technical implementation, the vertical dynamics system can have a rubber-elastic stop buffer. In the event of greater compression, this comes into contact with the damper tube of the vertical dynamics system and acts as an additional spring that limits the compression travel to a maximum value. By providing the stop buffer, the compression characteristic curve increases progressively towards the maximum compression travel, i.e. the spring stiffness of the stop buffer increases.

The chassis control unit can control the vertical dynamics system with actuating forces with the help of which the available compression travel can be limited from the maximum compression travel to the reduced limit value, so that the stop buffer is not used or is only used partially.

If there are ground clearance problems during off-road driving, the user can limit the compression travel provided by the vertical dynamics system by operating the input means, whereby the chassis control unit sets a “virtual” stop buffer (by providing the appropriate actuating forces). For extreme ground clearance requirements, an additional “virtual” stop buffer can be installed, which further limits the compression travel provided by the vertical dynamics system.

The input means can be adjusted in steps or continuously. For example, the input means can be a slider with which the roll stiffness and the opposing articulation capability and/or the available compression travel can be continuously changed by the user.

### BRIEF DESCRIPTION OF THE FIGURES

Embodiments of the invention are described below with reference to the accompanying figures. In particular:

FIG. 1 shows a view illustrating the structure and function of the active chassis according to the invention.

FIG. 2 shows a view illustrating the structure and function of the active chassis according to the invention.

FIGS. 3a and 3b show a view illustrating the structure and function of the active chassis according to the invention.

FIGS. 4a and 4b show a view illustrating the structure and function of the active chassis according to the invention.

FIGS. 5a and 5b show a view illustrating the structure and function of the active chassis according to the invention.

FIGS. 6a and 6b show a view illustrating the structure and function of the active chassis according to the invention.

FIGS. 7a and 7b show a view illustrating the structure and function of the active chassis according to the invention.

FIGS. 8a and 8b show a view illustrating the structure and function of the active chassis according to the invention.

FIG. 9 shows a view illustrating the structure and function of the active chassis according to the invention.

### DETAILED DESCRIPTION

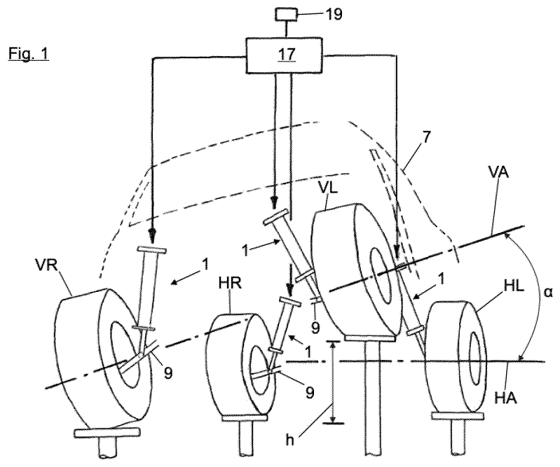

FIG. 1 shows an equivalent diagram of a two-track off-road vehicle that is in a driving position that simulates a ramp ride in off-road conditions, in which the front left vehicle wheel VL is offset in height relative to the other vehicle wheels VR, HL, HR by an offset h. Each of the vehicle wheels VL, VR, HL, HR is linked to the vehicle body 7 by means of independent wheel suspensions, which are not mechanically connected to the front axle VA or the rear axle HA via a stabilizer bar. It should be emphasized that the invention is not limited to a vehicle with independent wheel suspension. Rather, the invention is also applicable to a vehicle with rigid axles. In the case of rigid axles, the functionality according to the invention can also be implemented, albeit only to a limited extent, since the rigid axle represents a mechanical anti-roll spring.

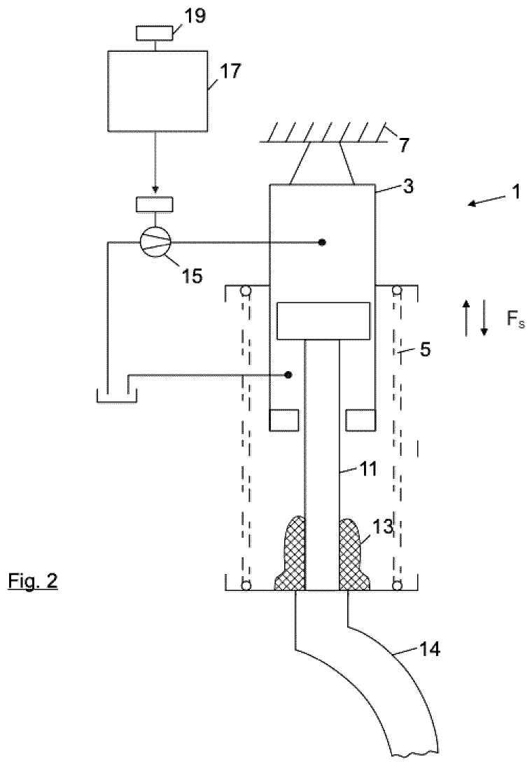

Each of the independent wheel suspensions has a vibration/damping device with a vertical dynamics system 1, which is roughly schematically indicated in FIG. 2 to the extent that it is necessary for understanding the invention. Accordingly, the vertical dynamics system 1 is formed from a telescopic shock absorber with a suspension spring 5 on which the vehicle body 7 is supported. The telescopic shock absorber is supported at the top on the vehicle body 7 and at the bottom via a support strut 14 (FIG. 2) on a wheel guide element 9. A piston rod 11 which extends into the damper tube 3 of the shock absorber has a rubber-elastic stop buffer 13 which acts as an additional spring during a compression process and limits the compression travel h to a maximum value hₘₐₓ that can be provided by the vibration/damping device.

As can be seen from FIG. 2, the piston rod 11 in the damper tube 3 defines a hydraulic chamber filled with oil, which is integrated into a hydraulic circuit together with an oil pump 15 acting as an actuator. The oil pump 15 is in signal connection with the chassis control unit 17. The chassis control unit 17 controls the oil pump 15 in order to pressurize the hydraulic chamber in the damper tube 3, whereby actuating forces Fs act on the piston rod 11, for example for driving dynamics control, level control and/or a stabilizer function.

In the driving position shown in FIG. 1, the front axle VA and the rear axle HA are articulated by an articulation angle α. A large articulation capability of the vehicle is advantageous in the driving position shown in FIG. 1 in that it prevents the front right vehicle wheel VR from lifting off the road and no longer being able to build up traction.

In general, the off-road capability of a vehicle depends in particular on its traction capability and its ground clearance. Adequate traction capability is achieved with low roll stiffness and thus increased articulation capability of the respective vehicle axles VA and HA. Conversely, sufficient ground clearance is achieved with high roll stiffness and thus low articulation capability of the vehicle axles VA, HA.

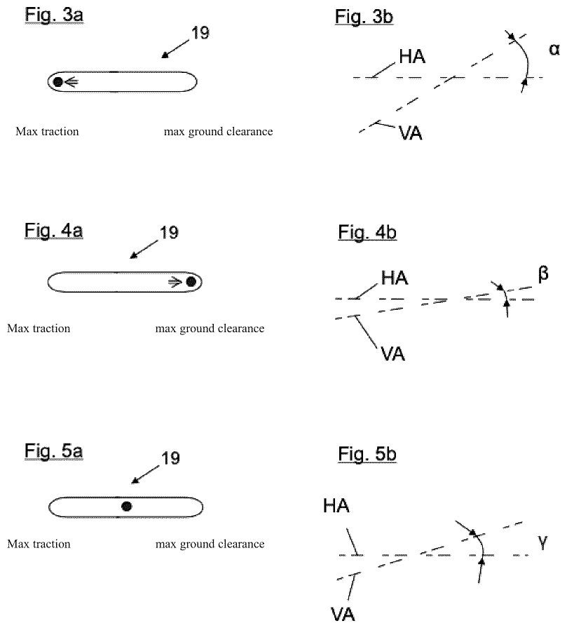

A core of the invention is based on the fact that an articulation-optimized control or system setting normally carried out automatically by the chassis control unit 17 can lead to insufficient ground clearance and/or insufficient traction during off-road driving. In order to eliminate such problems, according to the invention the chassis control unit 17 is assigned a user-operable input means 19. The input means 19 is implemented as a slider with which the user can continuously manually change the roll stiffness as well as the opposing articulation capability. As an example, in FIG. 3a the slide control 19 is adjusted to a left position, in which maximum traction is possible with minimum ground clearance. In the left setting position of the slide control 19, a minimum roll stiffness and thus an increased articulation capability is set, whereby a comparatively large articulation angle α (FIG. 3b) can be realized.

Alternatively, FIG. 4a provides maximum ground clearance with minimum traction capability. For this purpose, the slider 19 is set to a right position in which a maximum roll stiffness and thus a reduced articulation capability is set, whereby the articulation angle β (FIG. 4b) is smaller than the articulation angle α (FIG. 4a).

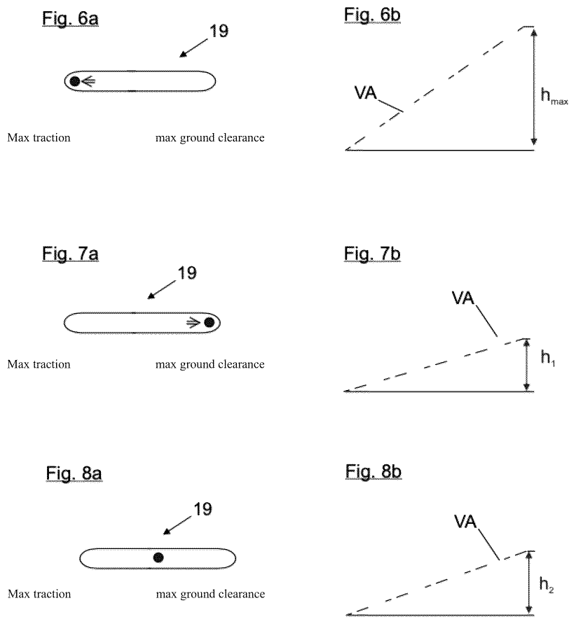

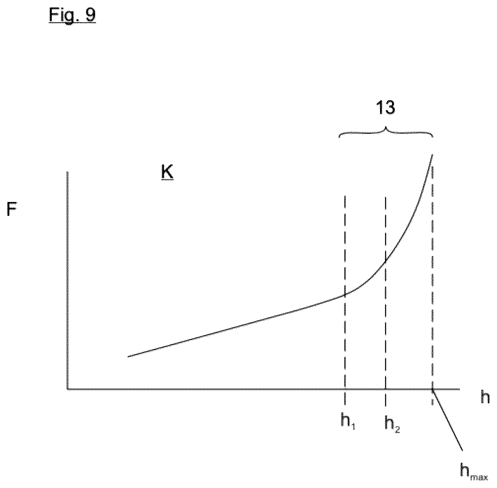

In the setting position of the slide control 19 shown in FIG. 5a, a medium traction capability and a medium ground clearance are provided. For this purpose, the slider 19 is moved to a middle position. In the middle position, a medium roll stiffness and a corresponding medium articulation capability result, where the articulation angle γ (FIG. 5b) takes on a mean value. Alternatively and/or additionally, the invention can also be implemented according to a second embodiment, which is illustrated with reference to FIGS. 6 to 9. Accordingly, the vertical dynamics system 1 can compress according to a compression characteristic curve K (FIG. 9). As an alternative to the first embodiment, the user-operated slider 19 is no longer used to manually adjust the roll stiffness (as in the first embodiment), but rather the compression characteristic K, that is, in particular, the characteristic curve gradient and/or a maximum compression travel hₘₐₓ that can be provided by the vertical dynamics system 1.

The second embodiment is based on the fact that ground clearance problems arising during off-road driving are usually solved by a reduction in the maximum compression travel hₘₐₓ that can be provided by the vertical dynamics system 1. By way of example, in FIG. 6a the slide control 19 is adjusted to a left position in which maximum traction capability is provided. In the left setting position, there is no limitation of the compression travel h of the vehicle wheels VL, VR, HR, HL, so that the maximum compression travel hₘₐₓ (FIG. 6b) can be provided. In contrast, in FIG. 7a the slide control 19 is adjusted to a right position in which maximum ground clearance is provided. In the right setting position, the compression travel is therefore limited to a maximum h to the first limit value h₁.

In FIG. 8a, the slide control 19 is adjusted to a middle position in which the vehicle has a medium traction capability and a medium ground clearance. In the middle setting position, a medium limitation of the compression travel h is therefore performed to a second limit value h₂, which lies between the first limit h₁ and the maximum adjustment travel hₘₐₓ.

The compression characteristic curve K of the vertical dynamics system 1 shown in FIG. 9 increases progressively with a correspondingly large compression and an increase in the spring stiffness. Accordingly, the characteristic curve K is linear and flat at a low and medium compression travel h and increases progressively until the maximum compression travel hₘₐₓ is reached, i.e. the spring stiffness of the stop buffer increases with increasing compression travel h. By appropriately controlling the oil pump 15 (or another equivalent actuator), actuating forces Fs can be built up in the vertical dynamics system 1, with the help of which the available compression travel h can be limited to the respective limit value h₁, h₂. With such a limitation of the compression travel h, the stop buffer 13 remains inoperative (at limit value h₁) or the stop buffer 13 is only partially used. Instead of the stop buffer 13, “virtual” stop buffers are created by a force build-up, which limit the compression travel h to the respective limit values h₁, h₂.

### LIST OF REFERENCE NUMERALS

1 Vertical dynamics system
3 Telescopic shock absorber
5 Suspension spring
7 Vehicle body
9 Wheel guide element
11 Piston rod
13 Stop buffer
14 Support strut
15 Oil pump
17 Chassis control unit
19 Input means

VR, VL, HR, HL Vehicle wheels
h Spring travel provided by the vertical dynamics system
   h₁, h₂ Limit values
   hₘₐₓ Maximum compression travel
   α, β, γ Articulation angle
VA Front axle
HA Rear axle
F Actuating force
K Compression characteristic curve

1. A vehicle with an active chassis, in which each vehicle wheel is linked to the vehicle body by a wheel suspension, which has a vibration/damping device with a vertical dynamics system that can be controlled by a chassis control unit, namely by adjusting the roll stiffness and the articulation capability of the vehicle, which behaves in the opposite direction,
wherein the chassis control unit is assigned a user-operable input means with which the roll stiffness and the opposing articulation capability can be manually adjusted, in particular during off-road driving.

2. The vehicle according to claim 1, wherein for maximum traction capability with minimum ground clearance, the input means can be adjusted to a setting position in which a minimum roll stiffness and thus an increased articulation capability is set.

3. The vehicle according to claim 1, wherein for maximum ground clearance with reduced traction capability, the input means can be adjusted to a setting position in which maximum roll stiffness and thus reduced articulation capability is set.

4. The vehicle according to claim 1, wherein for a medium traction capability and for a medium ground clearance, the input means is adjustable to a setting position in which a medium roll stiffness and a corresponding medium articulation capability are set.

5. A vehicle with an active chassis, in which each vehicle wheel is linked to the vehicle body by a wheel suspension which has a vibration/damping device with a vertical dynamics system which can be controlled by a chassis control unit, wherein the vertical dynamics system compresses according to a compression characteristic curve which increases progressively with a correspondingly large compression as the spring stiffness increases,
wherein the chassis control unit is assigned a user-operable input means with which the compression characteristic curve can be manually adjusted, in particular the characteristic curve gradient and/or the available compression travel, whereby sufficient ground clearance can be made available, in particular when driving off-road.

6. The vehicle according to claim 5, wherein for maximum traction capability, the input means can be adjusted to a setting position in which there is no limitation of the compression travel provided by the vertical dynamics system, i.e. a maximum compression travel is available.

7. The vehicle according to claim 5, wherein for maximum ground clearance, the input means can be adjusted to a setting position in which a maximum limitation of the compression travel provided by the vertical dynamics system up to a limit value takes place.

8. The vehicle according to claim 5, wherein for a medium traction capability and for a medium ground clearance, the input means can be adjusted to a setting position in which a medium limitation of the compression travel up to a limit value takes place.

9. The vehicle according to claim 5, wherein the vertical dynamics system has a rubber-elastic stop buffer which acts as an additional spring at a correspondingly large compression and limits the compression travel to a maximum value, and that the rubber-elastic stop buffer produces a compression characteristic curve which increases progressively towards the maximum compression travel and in particular the vertical dynamics system can be controlled by the chassis control unit with actuating forces with the aid of which the available compression travel can be reduced from the maximum compression travel to the reduced limit value so that in particular the stop buffer is not used or is only partially used.

10. The vehicle according to claim 1, wherein the input means is a slider with which the roll stiffness and the articulation capability acting in the opposite direction, and/or the available compression travel can be continuously changed by the user.

11. The vehicle according to claim 2, wherein for maximum ground clearance with reduced traction capability, the input means can be adjusted to a setting position in which maximum roll stiffness and thus reduced articulation capability is set.

12. The vehicle according to claim 2, wherein for a medium traction capability and for a medium ground clearance, the input means is adjustable to a setting position in which a medium roll stiffness and a corresponding medium articulation capability are set.

13. The vehicle according to claim 3, wherein for a medium traction capability and for a medium ground clearance, the input means is adjustable to a setting position in which a medium roll stiffness and a corresponding medium articulation capability are set.

14. The vehicle according to claim 6, wherein for maximum ground clearance, the input means can be adjusted to a setting position in which a maximum limitation of the compression travel provided by the vertical dynamics system up to a limit value takes place.

15. The vehicle according to claim 6, wherein for a medium traction capability and for a medium ground clearance, the input means can be adjusted to a setting position in which a medium limitation of the compression travel up to a limit value takes place.

16. The vehicle according to claim 7, wherein for a medium traction capability and for a medium ground clearance, the input means can be adjusted to a setting position in which a medium limitation of the compression travel up to a limit value takes place.

17. The vehicle according to claim 6, wherein the vertical dynamics system has a rubber-elastic stop buffer which acts as an additional spring at a correspondingly large compression and limits the compression travel to a maximum value, and that the rubber-elastic stop buffer produces a compression characteristic curve which increases progressively towards the maximum compression travel and in particular the vertical dynamics system can be controlled by the chassis control unit with actuating forces with the aid of which the available compression travel can be reduced from the maximum compression travel to the reduced limit value so that in particular the stop buffer is not used or is only partially used.

18. The vehicle according to claim 7, wherein the vertical dynamics system has a rubber-elastic stop buffer which acts as an additional spring at a correspondingly large compression and limits the compression travel to a maximum value, and that the rubber-elastic stop buffer produces a compression characteristic curve which increases progressively towards the maximum compression travel and in particular the vertical dynamics system can be controlled by the chassis control unit with actuating forces with the aid of which the available compression travel can be reduced from the maximum compression travel to the reduced limit value so that in particular the stop buffer is not used or is only partially used.

19. The vehicle according to claim 8, wherein the vertical dynamics system has a rubber-elastic stop buffer which acts as an additional spring at a correspondingly large compression and limits the compression travel to a maximum value, and that the rubber-elastic stop buffer produces a compression characteristic curve which increases progressively towards the maximum compression travel and in particular the vertical dynamics system can be controlled by the chassis control unit with actuating forces with the aid of which the available compression travel can be reduced from the maximum compression travel to the reduced limit value so that in particular the stop buffer is not used or is only partially used.
